(19) United States
(12) Patent Application Publication
(10) Pub. No.: US 2007/0273625 A1
(43) Pub. Date: Nov. 29, 2007

(54) METHOD AND APPARATUS FOR TRANSITING DISPLAY PANEL

(76) Inventor: Jung-Chieh Cheng, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,927

(22) Filed: May 26, 2006

(51) Int. Cl. G09G 3/36

(52) U.S. Cl. 345/87

(57) ABSTRACT

A method and apparatus for the transition of display panel are provided. The method and apparatus are applied to a display panel which is transforming from an abnormal display state into a normal display state. The display panel includes a data electrode and a reference electrode. According to this invention, a low-frequency alternative voltage signal is applied to the reference electrode together with a driving voltage designed to be applied to the data electrode. Then, a transformation electric field which is formed between the reference electrode and the data electrode makes the display panel transform into the normal display state quickly.

### BACKGROUND OF THE INVENTION

1. Field of Invention

The present invention relates to a method for transiting a display panel. More particularly, the present invention relates to a method for transiting a display panel driven by a low frequency alternative voltage.

2. Description of Related Art

A display panel can be categorized into several different types according to the materials, driving methods and light source arrangements. The optically compensated birefringence (OCB) liquid crystal display (LCD) has quick response speed and is able to provide the computer to continuously play fast changing pictures such as animations or movies so as to show fine pictures, and thus it is very suitable for a high-level LCD. However, the optically compensated birefringence LCD (hereinafter “OCB-LCD”) enters a standby state only after making the optically compensated birefringence liquid crystal molecules (“OCB liquid crystal molecules”) transformed from a splay state to a bend state, thereby performing a quick response function.

FIG. 1A depicts a schematic view of OCB liquid crystal molecules in the splay state. FIG. 1B depicts a schematic view of OCB liquid crystal molecules in the bend state. Referring to FIGS. 1A and 1B, a conventional OCB-LCD 100 has OCB liquid crystal molecules 130 disposed between a color filter substrate 110 and a thin film transistor array substrate 120. The color filter substrate 110 has a reference electrode 112, while the thin film transistor array substrate 120 has multiple data electrodes 122 (only one is shown in the figure). As shown in FIG. 1A, when no voltage is applied to the reference electrode 112 and the data electrode 122, the OCB liquid crystal molecules 130, without being influenced by the additional electric field, are arranged in the splay state. However, as shown in FIG. 1B, when the OCB-LCD 100 tends to enter the standby state, a voltage must be applied to the reference electrode 112 and the data electrode 122 respectively to produce a transformation electric field E perpendicular to the color filter substrate 110 and the thin film transistor array substrate 120. Under the influence of the perpendicular transformation electric field E, the OCB liquid crystal molecules 130 are transformed into the bend state gradually.

However, if it is desired to drive the conventional OCB-LCD 100 normally, the transition process takes several minutes, i.e., the OCB-LCD 100 requires a long warm up time before entering the standby state. Thus, it limits the instant-on feature of the OCB-LCD 100. Therefore, in order for customers to accept the OCB-LCD 100 more easily, it is essential that the OCB-LCD has a fast transition.

In the conventional technology, the method for making the OCB liquid crystal molecules quickly transform from the splay state to the bend state is applying high voltage between the color filter substrate 110 and the thin film transistor array substrate 120, as shown in FIG. 1B. When affected by the transformation electric field E produced by high voltage, the OCB liquid crystal molecules 130 will be quickly transformed from the splay state to the bend state. However, the amount of source ICs that can be correspondingly used in the method of applying high voltage is small. Besides, in the method, since the OCB-LCD is continuously turned on and off, the OCB liquid crystal molecules will be applied to a high voltage for a long time which results in accumulated charges on the liquid crystal. Consequently, it affects the quality of the liquid crystal and causes instability of the product.

At present, an apparatus and method for driving liquid crystal panel is disclosed by U.S. Pat. No. 6,476,792, in which the OCB liquid crystal molecules are transformed quickly through a voltage pulse. FIG. 2 depicts a block circuit diagram of the control unit the liquid crystal panel control unit according to the patent. Referring to FIG. 2, the main components of the control unit 200 include a control circuit 210, a transformation driving circuit 220, a display-driving circuit 230, and a switch 240. The transformation driving circuit 220 is used to generate a transformation voltage for making the OCB liquid crystal molecules transform from the splay state to the bend state, while the display-driving circuit 230 is used to generate a driving voltage for normal display. The control circuit 210 controls the whole driving voltage (V_{drive}) output by the control unit 200 through the control switch 240, such that the driving voltage (V_{drive}) can be the transformation voltage output by the transformation driving circuit 220 or the image signal output by the display-driving circuit 230. The driving voltage (V_{drive}) is electrically connected to the data electrode 122 of FIG. 1B. Therefore, a potential difference is generated between the constant voltage of the reference electrode 112 and the driving voltage (V_{drive}) of the data electrode 122 in FIG. 1B, and the potential difference causes an electric field, enabling the OCB liquid crystal molecules 130 being transformed and driven during the normal display.

FIG. 3 depicts a waveform chart of the output voltage of the control unit according to the patent. In the figure, the driving voltage (V_{drive}) is a square wave of fixed cycle with an amplitude of −30˜0 volts during the transition. And after the transition, the OCB liquid crystal molecules have been transformed from the splay state into the bend state and can be driven normally during the display.

For example, in U.S. Pat. No. 6,476,792, the transformation driving circuit 220 is added in the circuit, increasing the complexity of the circuit, thereby enlarging the area of the circuit board. During the transition period, only a negative voltage is applied to transform the OCB liquid crystal molecules between the reference electrode 112 and the data electrode 122, so charges are easily accumulated on the OCB liquid crystal molecules, which influences the display quality and adversely affects the OCB liquid crystal molecules. Thus, the stability of the product is deteriorated.

### SUMMARY OF THE INVENTION

In view of the above, an object of the present invention is to provide a method for transiting a display panel. The method is applied to a display panel which is transiting from an abnormal display state to a normal display state. In addition, a low-frequency alternative voltage is supplied to drive the OCB-LCD and make the OCB liquid crystal molecules transform from the splay state to the bend state quickly, thus shortening the warm up time and preventing the charges being accumulated on the OCB liquid crystal molecules which can cause bad effect on the liquid crystal.

Another object of the invention is to provide an apparatus for transiting a display panel without increasing the complexity of the circuit in the original display panel, which can be fulfilled only by changing a small part of the circuit, thus avoiding changing the whole procedure and design of the panel.

Based on the above and other objects, the invention provides a method for transiting a display panel. The method is applied to a display panel which is transforming from an abnormal display state into a normal display state during the transition, wherein the display panel includes a data electrode and a reference electrode. The method for transiting the display panel includes: supplying a reference voltage to the reference electrode and supplying a driving voltage to the data electrode during the transition to produce a transformation electric field between the reference electrode and the data electrode, wherein the reference voltage is switched between a first voltage level and a second voltage level in a predetermined frequency.

According to the method for transiting a display panel in the preferred embodiment of the invention, the predetermined frequency mentioned above is between 2 Hz and 60 Hz.

According to the method for transiting a display panel in the preferred embodiment of the invention, when the display panel is in the normal display state, the level of the reference voltage mentioned above remains at a third voltage level.

According to the method for transiting a display panel of the preferred embodiment of the invention, the driving voltage is switched between a fourth voltage level and a fifth voltage level in a predetermined frequency, or remains at a sixth voltage level during the transition.

According to the method for transiting a display panel of the preferred embodiment of the invention, a display light source of the display panel is turned off during the transition and the display light source of the display panel is turned on after the transition.

According to the method for transiting a display panel of the preferred embodiment of the invention, the aforementioned display panel includes an OCB liquid crystal display panel.

According to the method for transiting a display panel of the preferred embodiment of the invention, the aforementioned display panel includes a color filter substrate and a thin film transistor array substrate, and the reference electrode is disposed on the color filter substrate, while the data electrode is disposed on the thin film transistor array substrate.

From another point of view, the invention provides an apparatus for the transition of display panel. The apparatus is applied to the display panel which is transforming from an abnormal display state into a normal display state, wherein the display panel includes a data electrode and a reference electrode. The apparatus includes a reference voltage unit, a Gamma voltage unit, a data driver and a controller. The reference voltage unit is used for outputting the reference voltage to the reference electrode of the display panel. The Gamma voltage unit is used for outputting multiple Gamma voltages. The data driver is electrically connected to the Gamma voltage unit for selecting one of the multiple Gamma voltages based on the display data and accordingly outputting a driving voltage to the data electrode of the display panel. The controller is electrically connected to the reference voltage unit, the data driver, and the Gamma voltage unit, for outputting the display data to the data driver. During the transition, the controller controls the reference voltage unit to make the reference voltage switch between a first voltage level and a second voltage level in a predetermined frequency, so as to form a transformation electric field between the reference electrode and the data electrode.

According to the apparatus for the transition of display panel of the preferred embodiment of the invention, during the above-mentioned transition, the controller controls the Gamma voltage unit to make every Gamma voltage switch between a fourth voltage level and a fifth voltage level in a predetermined frequency.

According to the apparatus for the transition of display panel of the preferred embodiment of the invention, the above-mentioned Gamma voltage includes multiple positive Gamma voltages and multiple negative Gamma voltages. During the transition, the controller controls the Gamma voltage unit to make multiple positive Gamma voltages remain at the fourth voltage level and make multiple negative Gamma voltages remain at the fifth voltage level.

According to the apparatus for the transition of display panel of the preferred embodiment of the invention, the above-mentioned controller is electrically connected to the light source driver of the display panel, for turning off the display light source of the display panel through controlling the light source driver of the display panel during the transition, and turning on the display light source of the display panel through controlling the light source driver of the display panel after the transition.

According to the present invention, a low-frequency alternative voltage signal is applied to the reference electrode together with a driving voltage designed to be applied to the data electrode, to form a transformation electric field between the reference electrode and the data electrode for enabling the display panel to transform into the normal display state quickly. Besides, during the transition, the continuous change of the polarity of the transformation electric field prevents charges being accumulated on the OCB liquid crystal molecules which bring bad effect to the liquid crystal. And only a small part of the circuit is changed, thus avoiding changing the whole procedure and design of the panel.

In order to the make the aforementioned and other objects, features and advantages of the present invention comprehensible, a preferred embodiment accompanied with figures is described in detail below.

### BRIEF DESCRIPTION OF THE DRAWINGS

FIG. 1A depicts a schematic view of the OCB liquid crystal molecules in the splay state;

FIG. 1B depicts a schematic view of the OCB liquid crystal molecules in the bend state;

FIG. 2 depicts a block circuit diagram of the control unit of the liquid crystal display panel according to U.S. Pat. No. 6,476,792;

FIG. 3 depicts a waveform chart of the output voltage of the control unit according to the '792 patent;

FIG. 4 depicts a schematic sectional view of an OCB-LCD according to the preferred embodiment of the invention;

FIG. 5 depicts a block circuit diagram of an OCB-LCD according to the preferred embodiment of the invention;

FIG. 6 depicts a waveform chart of the method for transiting the display panel according to the preferred embodiment of the invention;

FIG. 7 depicts a waveform chart of the method for transiting the display panel according to the preferred embodiment of the invention;

FIG. 8 depicts a schematic circuit diagram of the Gamma voltage unit according to the preferred embodiment of the invention;

FIG. 9A depicts a waveform chart of the method for transiting display panel according to the preferred embodiment of the invention;

FIG. 9B depicts a waveform chart of the method for transiting the display panel according to the preferred embodiment of the invention;

FIG. 10 depicts a schematic circuit diagram of the Gamma voltage unit according to the preferred embodiment of the invention;

FIG. 11 depicts a waveform chart of the method for transiting the display panel according to the preferred embodiment of the invention; and

FIG. 12 depicts a schematic circuit diagram of the Gamma voltage unit according to the preferred embodiment of the invention.

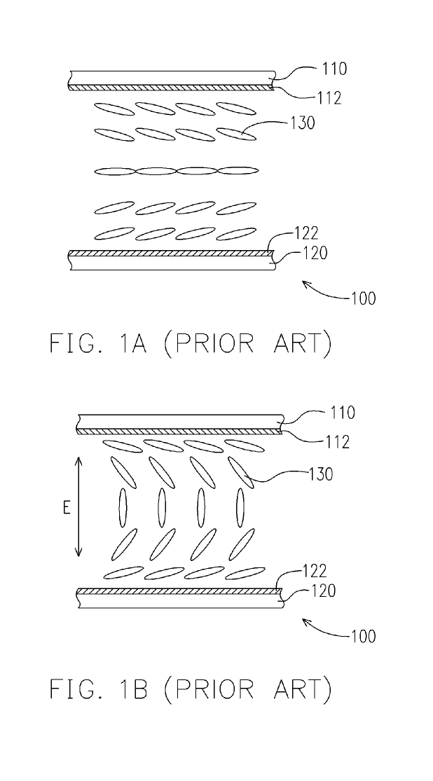

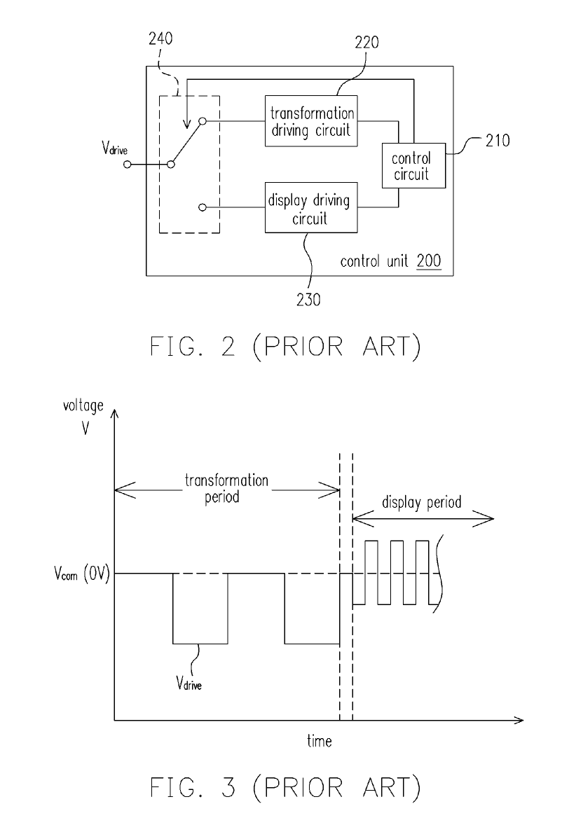

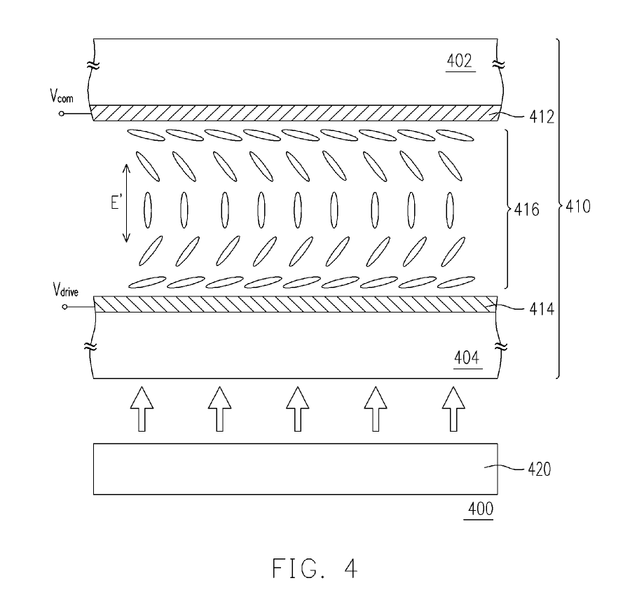

### DESCRIPTION OF EMBODIMENTS

According to the invention, when starting the display panel (for example, making the OCB liquid crystal display panel transform from the splay state to the bend state), a transformation electric field of low-frequency alternative voltage is generated at first, making the display panel transform from a abnormal display state into a normal display state, thereby shortening the warm up time of the display. The invention is illustrated by embodiments as follows, but is not limited to those. Those skilled in the art can make some modifications according to the spirit of the invention without departing from the scope of the invention. For illustrating the embodiment of the invention, an OCB-LCD is taken as an example of the display to be driven in the invention.

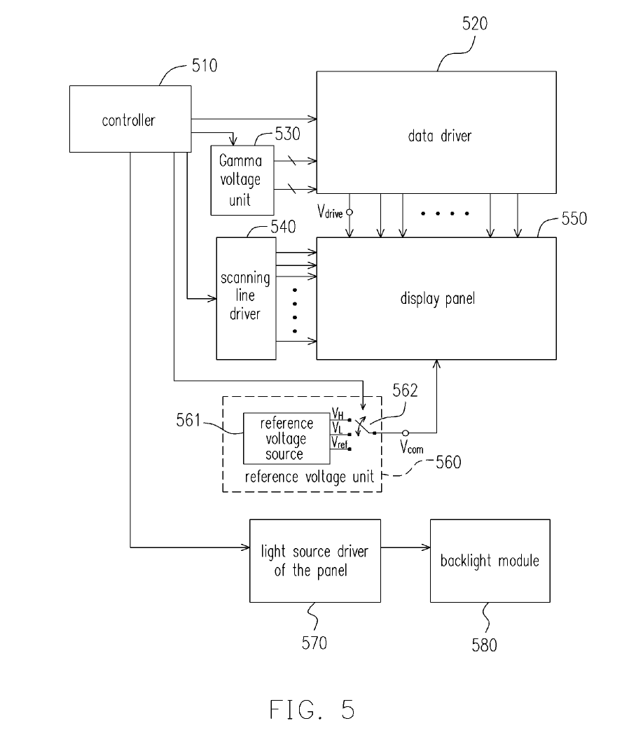

FIG. 4 depicts a schematic sectional view of an OCB-LCD according to the preferred embodiment of the invention. Referring to FIG. 4, a display 400 includes a display panel 410 and a backlight module 420, wherein the display panel 410 includes a reference electrode 412, multiple data electrodes 414, and an OCB liquid crystal layer 416 disposed between the reference electrode 412 and the data electrodes 414. The reference electrode 412 is formed on a substrate 402, and the substrate 402 is, for example, a color filter substrate. And the data electrodes 414 are formed on another substrate 404, for example, a thin film transistor array substrate. In the embodiment, if the display 400 is an active LCD, the reference electrode 412 is a common electrode and the data electrode 414 is multiple pixel electrodes (only one is shown in the figure), and each of the pixel electrodes is electrically connected to an active element, such as, a thin film transistor. Furthermore, the backlight module 420 is disposed at the back of the liquid crystal display panel 410 to supply the desired light source for the display 400 to display images.

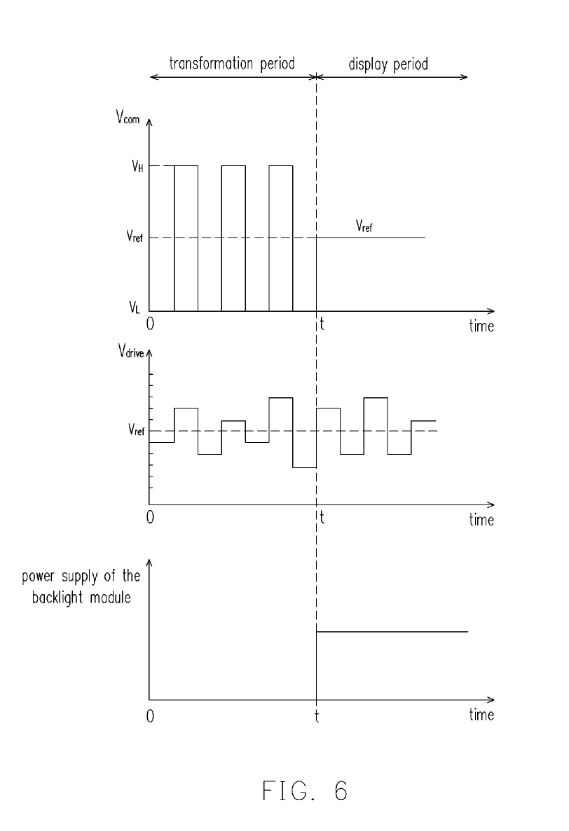

FIG. 5 depicts a block circuit diagram of an OCB-LCD according to the preferred embodiment of the invention. In FIG. 5, the main components includes a controller 510, a data driver 520, a Gamma voltage unit 530, a scanning line driver 540, a display panel 550, a reference voltage unit 560, a panel light source driver 570, and a backlight module 580. The controller 510 is electrically connected to the data driver 520, Gamma voltage unit 530, scanning line driver 540, reference voltage unit 560, and panel light source driver 570 respectively for controlling the circuit of each part and outputting data thereto. The Gamma voltage unit 530 is used for outputting multiple Gamma voltages, and in the embodiment, the Gamma voltage unit 530 outputs, for example, five groups of positive Gamma voltages and five groups of negative Gamma voltages. The data driver 520 is electrically connected to the Gamma voltage unit 530 and selects one Gamma voltage according to the display data for outputting a driving voltage (V_{drive}) to the data electrode of the display panel 550.

The reference voltage unit 560 includes a reference voltage source 561 and a switch 562. The reference voltage source 561 provides three different voltage levels, V_{H}, V_{L}, and V_{ref}. The controller 510 outputs a control signal to control the switch 562 for determining the voltage level output from the reference voltage unit 560 to the reference electrode of the display panel 550. The panel light source driver 570 is electrically connected to the backlight module 580, for driving the backlight module 580 so as to provide the desired display light source for the display panel 550.

In this embodiment, the display panel 550 includes multiple pixels, and the structure of each pixel is the same as the structure of the display panel 410 in the OCB-LCD 400 of FIG. 4. The driving voltage V_{drive} output by the data driver 520 is applied, for example, to the data electrode 414 in FIG. 4, and the reference voltage V_{com} output by the reference voltage unit 560 is also applied, for example, to the reference electrode 412 in FIG. 4, so as to generate an electric field E′ between the reference electrode 414 and the data electrode 412 for driving the OCB liquid crystal layer 416.

The OCB-LCD should go through the transition to make the OCB liquid crystal molecules transform from the splay state to the bend state before entering the standby state, i.e. the normal display state, and then normally displays pictures. Four different transition methods for making the OCB-LCD quickly pass through the transition period and enter the normal display state are described according to the embodiment of the invention accompanied with FIGS. 4 and 5. However, those skilled in the art should know that the invention is not limited to the four methods.

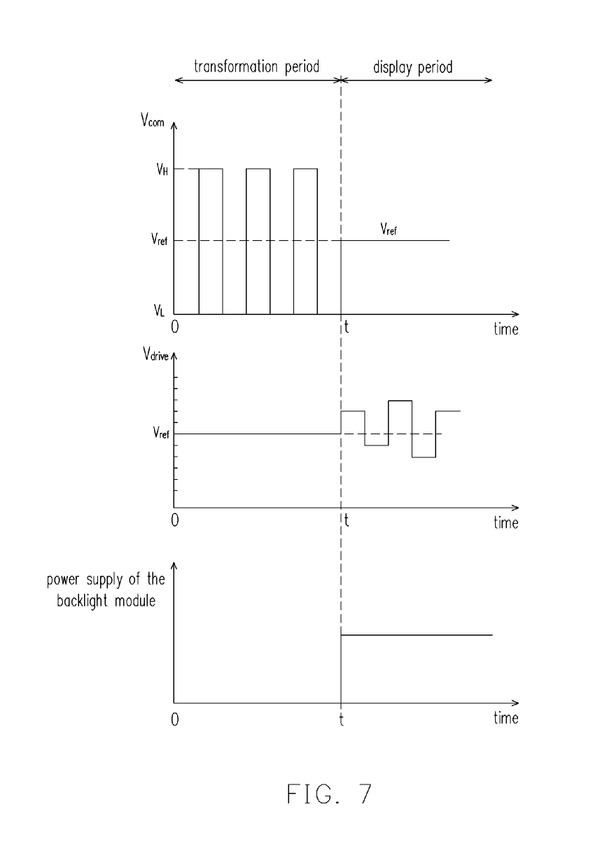

According to the first method, a pulse square wave voltage signal is applied to the reference electrode and a normal driving voltage is applied to the data electrode during the transition, to form a transformation electric field between the reference electrode and the data electrode, making the OCB-LCD quickly enter the normal display state. FIG. 6 depicts a waveform chart of the method for the transition of display panel according to the preferred embodiment of the invention. FIG. 6 depicts the wave forms of the reference voltage V_{com}, driving voltage V_{drive}, and the power supply of the backlight module. The time period 0˜t is the transition period in which the OCB-LCD is in the abnormal display state. After the time t, the transition period is over, and the display period begins (at this time, the OCB-LCD has been transformed into the normal display state).

Referring to FIGS. 4, 5, and 6, during the transition, the controller 510 outputs a control signal of predetermined frequency to control the switch 562, switching the switch 562 to output a first voltage level V_{H} and a second voltage level V_{L} in the predetermined frequency. Therefore, the pulse square wave voltage signal with an amplitude of V_{L}˜V_{H} output by the reference voltage unit 560 during the transition is taken as the reference voltage V_{com}. Herein, the predetermined frequency of the above-mentioned control signal determines the switching frequency of the switch and further determines the frequency of the reference voltage V_{com}. In the embodiment, the predetermined frequency is in the range of 2 Hz to 60 Hz, but is not limited to this. During the transition period, the data driver 520 and the Gamma voltage unit 530 output the driving voltage V_{drive} as the normal data signal. The driving voltage V_{drive} is applied to the data electrode 414 of FIG. 4, and the reference voltage V_{com} is also applied to the reference electrode 412 of FIG. 4, so as to form a transformation electric field between the data electrode 414 and the reference electrode 412, thereby enabling the OCB liquid crystal molecules to transform from the splay state to the bend state quickly. Besides, in the embodiment, the amplitude of the reference voltage V_{com} is larger than the amplitude of the driving voltage V_{drive} during the transition.

After the transition period, the OCB-LCD is in the normal display state. At this time, the controller 510 controls the switch 562 to switch to the third voltage level V_{ref}, making the level of the reference voltage V_{com} output by the reference voltage unit 560 remain at the third voltage level V_{ref}.

Furthermore, during the transition, as the voltage on the data electrode is not the desired driving voltage V_{drive}, resulting in an incorrect voltage of the OCB liquid crystal molecules, thereby causing the OCB-LCD display disordered pictures. Therefore, in practical applications, the controller 510 control the panel light source driver 570 to turn off the power supply of the backlight module 580, preventing the user from viewing the disordered pictures. Only after the transition period, the controller 510 controls the panel light source driver 570 to output power supply to the backlight module 580 for turning on the display light source of the display panel, thereby displaying pictures normally.

As shown in the first transition method mentioned above, the OCB-LCD can enter the normal display state quickly by adding one switch in the reference voltage unit 560 of the original display panel to receive the control signal of the controller. As such, the complexity of the circuit in the original display panel is not increased, and the object of the present invention can be achieved only by modifying the design of a small part of the circuit, thereby avoiding changing the whole procedure and design of the panel.

As shown in the wave forms of the driving voltage V_{drive} and the reference voltage V_{com} in FIG. 6, the positive or negative polarity of the voltage applied between the data electrode and the reference electrode of the display panel changes alternatively, making the OCB liquid crystal molecules continuously rotate so as to avoid charges accumulated on the OCB liquid crystal molecules, thereby increasing the stability of the OCB liquid crystal molecules.

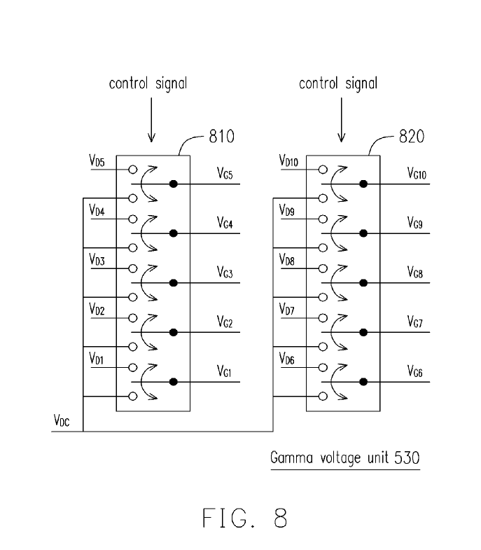

According to the second transition method, a pulse square wave voltage signal is applied to the reference electrode and a constant driving voltage is applied to the data electrode, so as to form a transformation electric field between the reference electrode and the data electrode, making the OCB-LCD transform into the normal display state quickly. FIG. 7 depicts a waveform chart of the method for transiting the display panel according to the preferred embodiment of the invention. FIG. 7 depicts the wave forms of the reference voltage V_{com}, the driving voltage V_{drive}, and the power supply of the backlight module, wherein the time period 0˜t is the transition period, in which the OCB-LCD is in the abnormal display state. After the time t, the transition period is over, and the display period begins (at this time the OCB-LCD has been transformed into the normal display state).

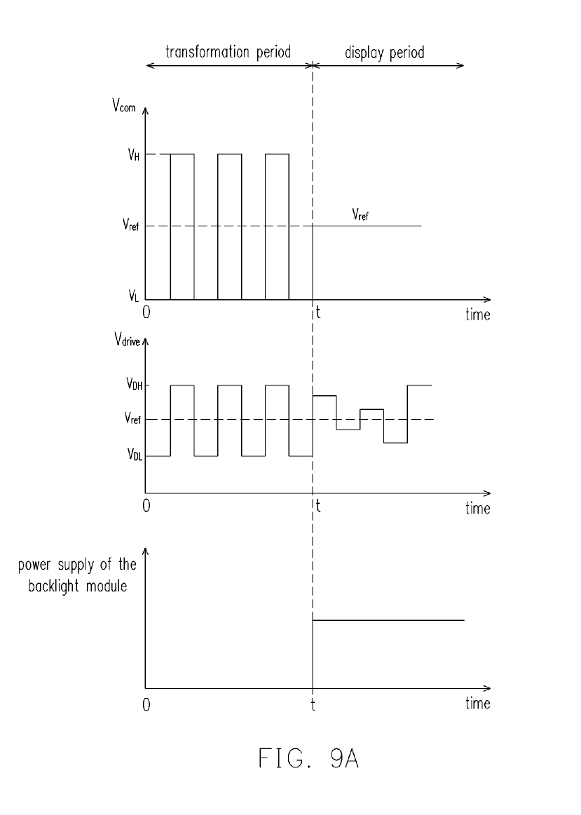

The second transition method is similar to the first transition method, except that during the transition, the driving voltage V_{drive} is no longer the data signal but the voltage of a fixed level. The Gamma voltage of a fixed level is generated by improving the Gamma voltage unit 530 of FIG. 5 during the transition. FIG. 8 depicts a schematic circuit diagram of the Gamma voltage unit according to the preferred embodiment of the invention.

FIG. 8 includes two groups of switches 810, 820. The Gamma voltage unit 530 outputs, for example, ten Gamma voltages V_{G1}˜V_{G10}, wherein V_{G1}˜V_{G5} are negative Gamma voltages and V_{G6}˜V_{G10} are positive Gamma voltages. V_{D1}˜V_{D10} are ten original Gamma voltage levels, and V_{DC} is the sixth voltage level. In this embodiment, the level of the sixth voltage level V_{DC} equals to that of the third voltage level V_{ref}. Referring to FIGS. 5, 7, and 8, during the transition, the controller 510 outputs a control signal for switching each of the switches 810 and 820 to the sixth voltage level V_{DC}. Meanwhile, the data driver 520 selects a Gamma voltage from V_{G1}˜V_{G10} according to the display data. However, at this time, in spite of which Gamma voltage being selected from V_{G1}˜V_{G10}, the sixth voltage level V_{DC} is output for making the data driver 520 output a driving voltage V_{drive} of a fixed voltage level V_{DC}.

After the transition, the OCB-LCD is in the normal display state. At this time, the controller 510 control each of the switches 810 and 820 to switch to the original Gamma voltage level V_{D1}˜V_{D10}, enabling the data driver 520 to output the corresponding driving voltage V_{drive} normally according to the display data during the display period.

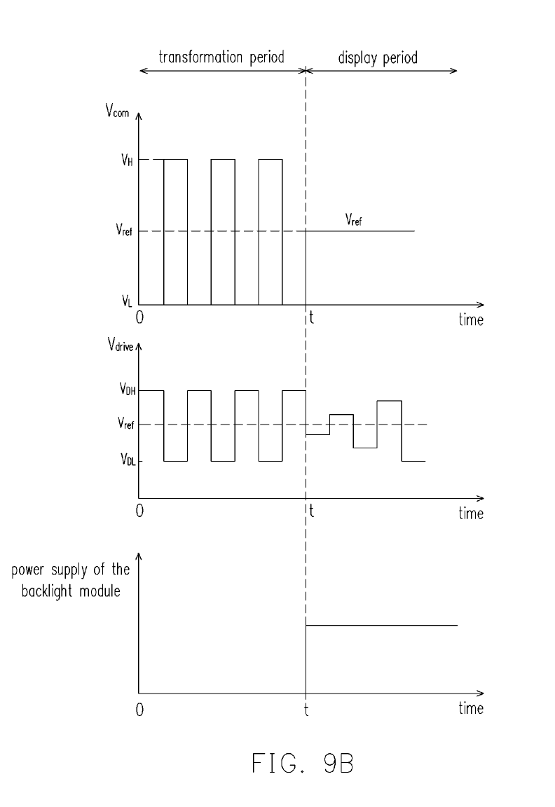

According to the third method, a pulse square wave voltage signal is applied to the reference electrode, and a constant driving voltage with positive or negative polarity is applied to the data electrode, so as to form a transformation electric field between the reference electrode and the data electrode, for making the OCB-LCD transform into the normal display state. FIG. 9A depicts a waveform chart of the method for the transition of display panel according to the preferred embodiment of the invention. FIG. 9A depicts the wave forms of the reference voltage V_{com}, the driving voltage V_{drive}, and the power supply of the backlight module. The time period 0˜t is the transition period, in which the OCB-LCD is in the abnormal display state. After the time t, the transition period is over, and the display period begins (at this time, the OCB-LCD has been transformed into the normal display state).

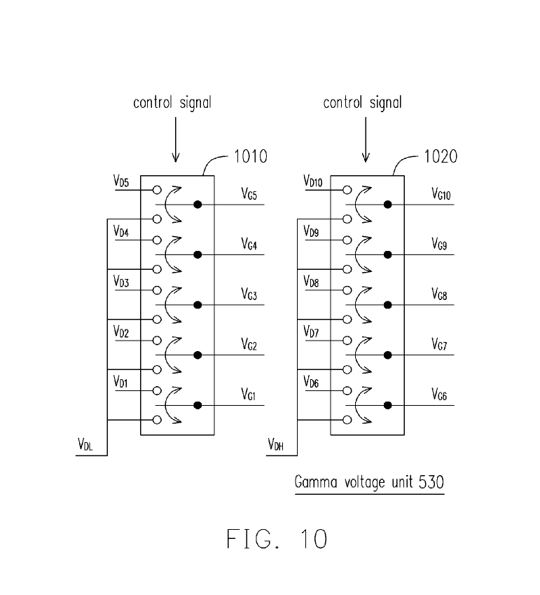

The third transition method is similar to the second transition method, except that the driving voltage V_{drive} is no longer a constant voltage but a voltage of positive or negative polarity. The Gamma voltage of positive or negative polarity is generated by improving the Gamma voltage unit 530 in FIG. 5. FIG. 10 depicts a schematic circuit diagram of the Gamma voltage unit according to the preferred embodiment of the invention.

FIG. 10 includes two groups of switches 1010, 1020. The Gamma voltage unit 530 outputs, for example, ten Gamma voltages V_{G1}˜V_{G10}, wherein V_{G1}˜V_{G5} are negative Gamma voltages and V_{G6}˜V_{G10} are positive Gamma voltages. V_{D1}˜V_{D10} are ten original Gamma voltage levels, and V_{DL} is the fifth voltage level and V_{DH} is the fourth voltage level. Referring to FIGS. 5, 9A, and 10, during the transition, the controller 510 outputs a control signal for switching five switches of the switch 1010 to the fifth voltage level V_{DL} and switching five switches of the switch 1020 to the fourth voltage level V_{DH}. Meanwhile, the data driver 520 selects one Gamma voltage from V_{G1}˜V_{G10} according to the display data. That is, when it is intended to output a negative driving voltage V_{drive}, the data driver 520 selects a Gamma voltage from V_{G1}˜V_{G5} according to the display data, and when it is intended to output a positive driving voltage V_{drive} is, the data driver 520 selects a Gamma voltage from V_{G6}˜V_{G10} according to the display data. However, when it is intended to output a negative driving voltage V_{drive}, no matter which negative Gamma voltage is selected from V_{G1}˜V_{G5}, the fifth voltage level V_{DL} is output; while when it is intended to output a positive driving voltage V_{drive}, no matter which positive Gamma voltage is selected from V_{G6}˜V_{G10}, the fourth voltage level V_{DH} is output for making the data driver 520 output a driving voltage V_{drive} only having positive or negative polarity. In this embodiment, the amplitude of the reference voltage V_{com} is larger than the amplitude of the driving voltage V_{drive}.

If the data driver 520 adopts a dot inversion driving method, the polarities of the adjacent pixels in the display panel 550 are opposite to each other. Therefore, if one data channel display panel 550 has a driving voltage as shown in FIG. 9A, the driving voltage V_{drive} of adjacent data channel has a wave form as shown in FIG. 9B. FIG. 9B depicts a waveform chart of the method for transiting the display panel according to the preferred embodiment of the invention. The polarity of the driving voltage V_{drive} is the same as the polarity of the reference voltage V_{com} in FIG. 9A, while the polarity of the driving voltage V_{drive} is opposite to the polarity of the reference voltage V_{com} in FIG. 9B. During the transition, when the polarity of the driving voltage V_{drive} is opposite to the polarity of the reference voltage V_{com}, the voltage between the data electrode and the reference electrode is the maximum, thereby enabling the OCB liquid crystal molecules to transform more quickly.

After the transition, the OCB-LCD is in the normal display state. At this time, the controller 510 controls the switches 1010 and 1020 to switch to the original Gamma voltage level V_{D1}˜V_{D10}, making the data driver 520 output the driving voltage V_{drive} normally according to the display data during the display period.

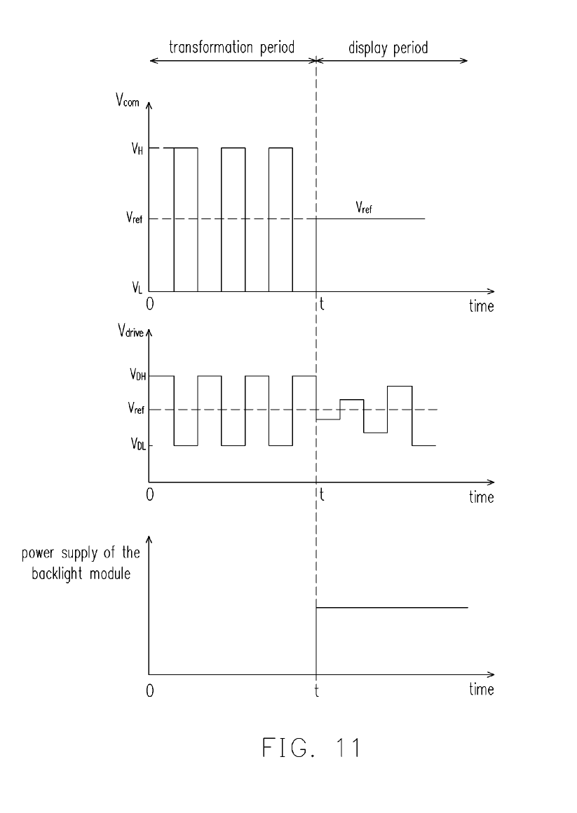

As the voltage between the data electrode and the reference electrode cannot be fixed on the maximum in the third transition method, a fourth transition method is provided. According to the fourth transition method, during the transition, a pulse square wave voltage signal is applied to the reference electrode and a pulse square wave voltage signal is applied to the data electrode so as to form a transformation electric field between the reference electrode and the data electrode, for making the OCB-LCD enter the normal display state. FIG. 11 depicts a waveform chart of the method for transiting the display panel according to the preferred embodiment of the invention. FIG. 11 depicts the wave forms of the reference voltage V_{com}, the driving voltage V_{drive}, and the power supply of the backlight module. The time period 0˜t is the transition period in which the OCB-LCD is in the abnormal display state. After the time t, the transition period is over, and the display period begins (at this time, the OCB-LCD has been transformed into the normal state).

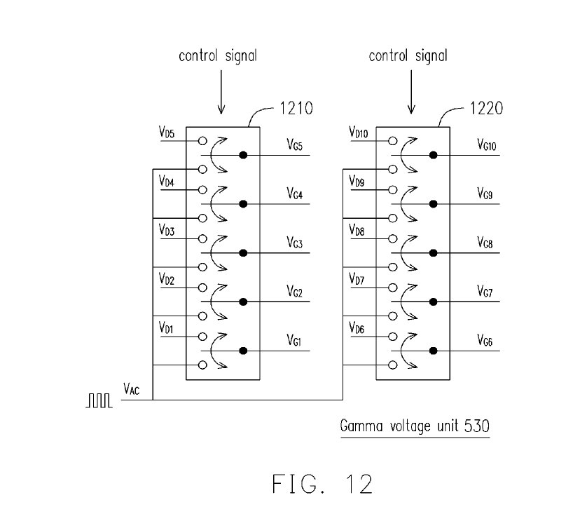

The fourth transition method is similar to the third transition method, except that during the transition, the driving voltage V_{drive} and the reference voltage V_{com} have opposite polarities at the same time. The Gamma voltage unit 530 in FIG. 5 is improved to make sure the driving voltage V_{drive} and the reference voltage output by the data driver 520 have opposite polarities. FIG. 12 depicts a schematic circuit diagram of the Gamma voltage unit according to the preferred embodiment of the invention.

In FIG. 12, two groups of switches 1210, 1220 are included. The Gamma voltage unit 530 outputs, for example, ten Gamma voltages V_{G1}˜V_{G10}, wherein V_{G1}˜V_{G5} are negative Gamma voltages and V_{G6}˜V_{G10} are positive Gamma voltages. V_{D1}˜V_{D10} are ten original Gamma voltage levels, and V_{AC} is a pulse square wave voltage signal. In the embodiment, the pulse square wave voltage signal V_{AC} is a square wave voltage having the same predetermined frequency as the reference voltage V_{com}, and being switched between the fourth voltage level V_{DH} and a fifth voltage level V_{DL}. Moreover, during the transition, the polarities of the pulse square wave voltage signal V_{AC} and the reference voltage V_{com} are opposite at the same time.

Referring to FIGS. 5, 11, and 12, during the transition, the controller 510 outputs a control signal, and the control signal makes each switch of the switches 1210 and 1220 switch to the pulse square wave voltage signal V_{AC}. At this time, the data driver 520 still selects a Gamma voltage from V_{G1}˜V_{G10}, and no matter which Gamma voltage is selected from V_{G1}˜V_{G10}, the pulse square wave voltage signal V_{AC} is output by the data driver 520 as the driving voltage V_{drive}. During the transition period, since the pulse square wave voltage signal V_{AC} has the same frequency as the pulse square wave voltage signal output by the reference voltage source 561 and both of the square wave voltages signals are synchronous, the polarities of the driving voltage V_{drive} and the reference voltage V_{com} being opposite at any time can be ensured and the pulse square wave voltage signal V_{AC} is switched between the fourth voltage level V_{DH} and the fifth voltage level V_{DL}. Moreover, in this embodiment, the amplitude of the reference voltage V_{com} is larger than that of the driving voltage V_{drive}.

After the transition, the OCB-LCD is in the normal display state. At this time, the controller 510 controls the switches 1210 and 1220 to switch to the original Gamma voltage level V_{D1}˜V_{D10}, enabling the data driver 520 to normally output the driving voltage V_{drive} according to the display data.

To sum up, this invention provides a method for transiting a display panel, in which a low-frequency alternative voltage signal is applied to the reference electrode and a driving voltage is applied to the data electrode so as to form a transformation electric field between the reference electrode and the data electrode, for making the display panel transform into the normal display state quickly. Furthermore, during the transition, the polarity of the transformation electric field applied to the reference electrode and the data electrode changes continuously, avoiding charges accumulated on the OCB liquid crystal molecules which has bad effect on the liquid crystal, and also avoiding the voltage applied to the liquid crystal molecules which affects the quality of the display during the display period. The apparatus for the transition of display panel provided by the invention does not increase the complexity of the circuit of the original display panel and can be achieved by only changing a small part of the circuit, thereby avoiding changing the whole procedure and design of the panel.

Though the present invention has been disclosed above by the preferred embodiments, it is not intended to limit the invention. Anybody skilled in the art can make some modifications and variations without departing from the spirit and scope of the invention. Therefore, the protecting range of the invention falls in the appended claims.

What is claimed is:

1. A method for transiting a display panel, used for transforming a display panel from an abnormal display state into a normal display state during a transition period, wherein the display panel includes a data electrode and a reference electrode, the method for transiting a display panel comprising:
applying a reference voltage to the reference electrode and applying a driving voltage to the data electrode during the transition period, so as to form a transformation electric field between the reference electrode and the data electrode, wherein the reference voltage is switched between a first voltage level and a second voltage level in a predetermined frequency.

2. The method for transiting a display panel according to claim 1, wherein the predetermined frequency is between 2 Hz and 60 Hz.

3. The method for transiting a display panel according to claim 1, wherein the amplitude of the reference voltage is larger than the amplitude of the driving voltage.

4. The method for transiting a display panel according to claim 1, wherein when the display panel is in the normal display state, the level of the reference voltage remains at a third voltage level.

5. The method for transiting a display panel according to claim 1, wherein during the transition period, the driving voltage is switched between a fourth voltage level and a fifth voltage level in the predetermined frequency.

6. The method for transiting a display panel according to claim 1, wherein the driving voltage remains at a sixth voltage level during the transition period.

7. The method for transiting a display panel according to claim 1, further comprising:
turning off the display light source of the display panel during the transition period; and
turning on the display light source of the display panel after the transition period.

8. The method for transiting a display panel according to claim 1, wherein the display panel includes an optically compensated birefringence (OCB) liquid crystal display panel.

9. The method for transiting a display panel according to claim 1, wherein the display panel includes a color filter substrate and a thin film transistor array substrate, and the reference electrode is disposed on the color filter substrate while the data electrode is disposed on the thin film transistor array substrate.

10. An apparatus for the transition of display panel, used for transforming a display panel transform from an abnormal display state into a normal display state during a transition period, wherein the display panel includes a data electrode and a reference electrode, the apparatus for the transition of display panel comprising:
a reference voltage unit, for outputting a reference voltage to the reference electrode of the display panel;
a Gamma voltage unit, for outputting multiple Gamma voltages;
a data driver, electrically connected to the Gamma voltage unit, for selecting one of the Gamma voltages according to a display data and accordingly outputting the driving voltage to the data electrode of the display panel; and
a controller, electrically connected to the reference voltage unit, the data driver, and the Gamma voltage unit, for outputting the display data to the data driver; wherein during the transition period, the controller controls the reference voltage unit to make the reference voltage switch between a first voltage level and a second voltage level in a predetermined frequency, so as to form a transformation electric field between the reference electrode and the data electrode.

11. The apparatus for the transition of display panel according to claim 10, wherein the predetermined frequency is between 2 Hz and 60 Hz.

12. The apparatus for the transition of display panel according to claim 10, wherein the amplitude of the reference voltage is larger than the amplitude of the driving voltage.

13. The apparatus for the transition of display panel according to claim 10, wherein when the display panel is in the normal display state, the controller controls the reference voltage unit to make the level of the reference voltage remain at a third voltage level.

14. The apparatus for the transition of display panel according to claim 10, wherein during the transition period, the controller controls the Gamma voltage unit to make the Gamma voltages switch between a fourth voltage level and a fifth voltage level in the predetermined frequency.

15. The apparatus for the transition of display panel according to claim 10, wherein the Gamma voltages include multiple positive Gamma voltages and multiple negative Gamma voltages, and the controller controls the Gamma voltage unit during the transition period, for making the positive Gamma voltages remain at a fourth voltage level while making the negative Gamma voltages at a fifth voltage level.

16. The apparatus for the transition of display panel according to claim 10, wherein during the transition period, the controller controls the Gamma voltage unit for making the Gamma voltages remain at a sixth voltage level.

17. The apparatus for the transition of display panel according to claim 10, wherein the controller is further electrically connected to a panel light source driver, for turning off the display light source of the display panel through controlling the panel light source driver during the transition period; and after the transition period, turning on the display light source of the display panel through controlling the panel light source driver.

18. The apparatus for the transition of display panel according to claim 10, wherein the display panel includes an optically compensated birefringence (OCB) liquid crystal display panel.

19. The apparatus for the transition of display panel according to claim 10, wherein the display panel includes a color filter substrate and a thin film transistor array substrate, and the reference electrode is disposed on the color filter substrate, while the data electrode is disposed on the thin film transistor array substrate.
